(19) United States
(12) Patent Application Publication
(10) Pub. No.: US 2026/0002318 A1
(43) Pub. Date: Jan. 1, 2026

(54) A METHOD AND AN APPARATUS FOR THE PROCESSING OF LAUNDRY ITEMS

(71) Applicant: INWATEC APS, Odense SV (DK)

(72) Inventors: Laus Skovgård BIGUM, Odense SV (DK); Mads ANDRESEN, Odense SV (DK); Claes Stanley NIKOLAJSEN, Odense SV (DK); Steffan Boytang SØRENSEN, Odense SV (DK); Kasper SIMONSEN, Odense SV (DK); Tudor MORAR, Odense SV (DK)

(73) Assignee: INWATEC APS, Odense SV (DK)

(21) Appl. No.: 19/112,070

(22) PCT Filed: Sep. 14, 2023
(86) PCT No.: PCT/EP2023/075361

§ 371 Date: Mar. 14, 2025

(30) Foreign Application Priority Data
Sep. 16, 2022 (DK) PA202270450

(51) Int. Cl. D06F 95/00; B65G 47/90; D06F 89/00

(52) U.S. Cl. CPC D06F 95/00; B65G 47/90; B65G 2201/0229; D06F 89/00

(57) ABSTRACT

A method for processing clean/washed rectangular laundry items that includes receiving and holding on to one corner of each laundry item by a movable clamp of a laundry item transfer mechanism, draping by the clamp a length of a side of the laundry item adjacent to the one corner over clamping jaws of two clamping devices by inserting the clamp into a gap between opposite jaws of the two clamping devices. Holding on to the side of the laundry item by the clamping devices, and releasing the corner from the clamp, locating two adjacent corners of the laundry item by sliding at least one of the two clamping devices along the side to move the two clamping devices away from each other. Advancing the laundry item held by the clamping devices in a first machine direction.

The present invention generally concerns a method and an apparatus for the processing, normally in an industrial laundry facility, of clean/washed generally rectangular laundry items of the type having pairs of opposite edges, wherein the edges define opposite short sides and opposite long sides of the laundry item, respectively.

Large pieces of clean laundry, such as linen, are typically fed to an ironer from a washer/drier, and only then folded. Focus of the present invention is on laundry items that are normally fed to a folding machine from a washer/drier without any ironing, and where there is a need to fold the laundry items into a visually attractive high quality end-product having a rectangular shape, by the folding being about-or along with-the lines of symmetry of the laundry items.

Examples of prior art devices for the processing of flatwork are disclosed US2021/0172113 and U.S. Pat. No. 6,584,711.

There is a need for an improved apparatus and method that allows for high-speed processing of individual rectangular laundry items to be deposited onto a discharge conveyor in a configuration substantially without any folds and wherein two opposite edges of the laundry items may be oriented so as to be aligned with a machine direction of a downstream laundry folding machine.

### SUMMARY

In view of the above object, an apparatus of the present invention for the processing of clean/washed generally rectangular laundry items, defines a first machine direction and comprises a laundry item transfer mechanism with a movable clamp, components configured for holding each individual laundry item at or near two diagonally opposite corners, in a stretched out configuration and for presenting a hanging laundry item portion near or at one other corner of the laundry item to the movable clamp, two clamping devices for clamping engagement with a laundry item, the two clamping devices being displaceably mounted to be movable independently of each other parallel with a second machine direction perpendicular to the first machine direction, the clamp being movable into and along a respective gap between opposite jaws of the two clamping devices. By moving the clamp into and along the gaps to essentially drape the laundry items onto lower ones of the jaws a highly reliable deposition of the laundry items is achieved, resulting in less down-time and increased machine speed, factors that are essential to secure an economical operation of the apparatus.

In view of the above object, a first embodiment of a method according to the present invention may involve i) receiving and holding on to a laundry item portion near or at one corner of each laundry item by a movable clamp of a laundry item transfer mechanism, ii) then draping, by means of the clamp, a length of a first side of the laundry item adjacent to said one corner over clamping jaws of two clamping devices, by inserting the clamp into a gap between opposite jaws of the two clamping devices followed by a relative movement between the clamp and the clamping devices, iii) the holding on to said length of said first side of the laundry item by the clamping devices, and then releasing the laundry item portion from the clamp, iv) then moving the two clamping devices away from each other along said first side, with said laundry item hanging from said two clamping devices, towards two respective opposite second and third sides of the laundry item, v) then transferring the laundry item directly from the clamping devices to two aligning clamps, vi) then moving the two aligning clamps away from each other along said first side, with the laundry item hanging from the two aligning clamps, to said two respective opposite second and third sides of the laundry item, and vii) then advancing the laundry item hanging from the two aligning clamps in a first machine direction, preferably with a trailing portion of said laundry item lying against a receiving surface.

Preferably an alignment of the hanging laundry item is then carried out by a movement of the two aligning clamps relative to one another along the first machine direction.

Also in view of the above object, another embodiment of a method of the present invention may involve a) a step of receiving and holding on to a laundry item portion near or at one corner of each laundry item by a movable clamp of a laundry item transfer mechanism, b) a step of draping, by means of the clamp, a length of a first side of the laundry item adjacent to said laundry item portion over clamping jaws of two clamping devices, by inserting the clamp into a gap between opposite jaws of the two clamping devices followed by a relative movement between the clamp and the clamping devices, c) a step of holding on to the length of the first side of the laundry item by the clamping devices, and then releasing the laundry item portion from the clamp, d) a step of locating two opposite second and third sides of the laundry item by moving the two clamping devices along the first side, away from each other while still providing a clamping force against the laundry item, and then e) a step of advancing the laundry item still held by the clamping devices in a first machine direction, preferably with a trailing portion thereof lying against a receiving surface. Optionally, an alignment of the laundry item relative to the first machine direction is carried out by a movement of the two clamping devices relative to each other along the first machine direction, inter alia to correct for any misalignment arising from the manner in which the laundry item has been received by the pair of clamping devices.

Preferably, step d) is carried out while the laundry item hangs freely from the two clamping devices in front of the receiving surface.

While the moving carried out in step d) preferably is a movement where the clamping devices are in sliding engagement with the laundry item, the clamping devices may alternatively have rollers providing a clamping force against the laundry item while at the same time allowing for a reduced-friction movement along the first side of the clamping devices relative to the laundry item.

In an embodiment, prior to the draping step the laundry items are each presented to the clamp in a diagonally stretched configuration wherein a hanging portion at one corner thereof is received by the clamp, and wherein the clamp is then passed over respective lower jaws of the two clamping devices, in a gap between two opposite jaws, to carry out the draping step.

Laundry items processed using the present invention may by way of example be towels, bath mats and similar items, that typically may have dimensions of less than 80 cm×160 cm, that are typically woven with many protruding loops of thread, such as terrycloth, and that typically have a narrow stitched peripheral hem that defines the edges of the laundry item. Such laundry items typically leave the washer/drier in a disorderly and more or less intertwined manner.

Embodiments of the invention are defined in the dependent claims, providing a further increase in the processing speed of the individual rectangular laundry items.

### BRIEF DESCRIPTION OF THE DRAWINGS

FIG. 1 is a top view of a laundry item to be processed,

FIG. 2 is a schematic side view of an embodiment of an apparatus according to the present invention,

FIG. 3 is a schematic side view showing components for presenting each individual laundry item in a diagonally stretched configuration to a robotic component of the apparatus of FIG. 2,

FIG. 4a is a schematic perspective side view showing various components of a first and a second section of the apparatus of FIG. 2,

FIG. 4b is a side view showing a laundry item having been oriented and deposited onto a receiving surface,

FIGS. 5 and 6 are side perspective views showing a manipulator arm of a robotic device in positions for attacking a selected side of a laundry item,

FIG. 7 is a perspective view of two clamping devices, in a first relative position and each in a receiving configuration ready for receiving a length of a side of a laundry item,

FIG. 8 is a top perspective view showing the robotic device of FIGS. 5 and 6 ready to drape a length of a side of a laundry item across the lower jaws of the two clamping devices shown in the receiving configuration in FIG. 7,

FIG. 9 is a top view showing the robotic device of FIG. 8 having draped a length of a side of a laundry item across the lower jaws of the clamping devices in the receiving configuration shown in FIG. 7,

FIGS. 10 and 11 show the two clamping devices of FIG. 7 in different relative positions, configured for holding on to a laundry item (not shown) and in the process of locating two adjacent corners at a side of the laundry item,

FIG. 12 is a view similar to FIG. 8, where the laundry item is being draped over the lower jaws by movement of the robotic device in an opposite direction,

FIG. 13 is a top view showing an optional movement along a first machine direction of the apparatus as the two clamping devices are moved apart to locate two adjacent corners at the side of the laundry item,

FIG. 14 is a top perspective view showing a step of advancing the laundry item held by the clamping devices and lying flat against a surface, after having located the corners and with a simultaneous registration of the orientation of sides of the laundry item relative to a first machine direction of the apparatus,

FIG. 15 is a top view showing an alignment carried out by a further movement of the clamping devices relative to each other along the machine direction,

FIG. 16 is a rear perspective view showing a conveyor belt for receiving the aligned laundry item,

FIG. 17 exemplifies schematically how a portion of a laundry item may be received and held between opposite jaws of a clamping device,

FIG. 18 shows profiling of the engagement face of some of the jaws,

FIGS. 19a-19c show a second embodiment of the invention, illustrating the operation of dedicated aligning clamps used with the apparatus of FIG. 3, for aligning a misaligned laundry item, and

FIGS. 20a-20b show a third embodiment of the invention, illustrating the operation of a buffer component for use with the apparatus of FIG. 3.

### DETAILED DESCRIPTION

The present invention will now be explained in more detail below by reference to an embodiment shown in the appended drawings.

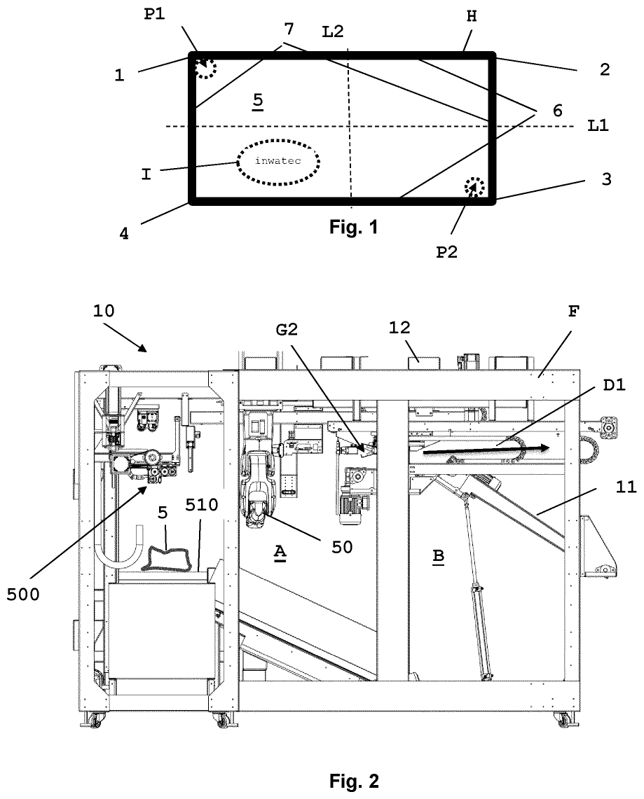

FIG. 1 shows a clean/washed rectangular laundry item 5 having opposite shorter sides 7 and opposite longer sides 6, wherein the sides 6, 7 of the items meet at respective geometric corners 1, 2, 3, 4.

Rectangular laundry items 5 as referred to herein may typically, but not exclusively, be towels or bath mats, which laundry items 5 are to be folded shortly after washing and drying, without any ironing. Towels and bath mats are typically of the terrycloth type, meaning they are typically woven and have protruding loops of thread, and have a narrow stitched peripheral hem H that defines the edges of the laundry item 5.

In some cases laundry items 5 to be processed using the invention may carry an indicia I, such as an owner's logo or a laundry item identifier, such as a QR-code, on one surface thereof.

In particular, the present invention allows for such rectangular laundry items 5 to be deposited individually onto a downstream discharge conveyor in a flat configuration wherein one pair of opposite sides of the laundry items 5 are oriented so as to be aligned with a specific machine direction of a downstream laundry folding machine, to thereby provide a flow of the laundry items 5 suitable for feeding directly into the laundry folding machine. In one use, such as where towels are processed, it may be desirable to align the two longer sides 6 thereof with the machine direction of the laundry folding machine, while in another use, such as where smaller laundry items 5 like bath mats are processed, it may be desirable to align the two shorter sides 7 thereof with the machine direction of the laundry folding machine.

Such an alignment allows the laundry folding machine to then fold the laundry items 5 into a high quality end-product having a rectangular shape, by the folding being about, or along with, the lines of symmetry L1, L2 of the laundry items 5.

In addition, the invention may also allow for the laundry items 5 to be presented to a laundry folding machine in a way that the folded end-product has one particular surface, such as the aforementioned surface carrying indicia I, being readily visible or inspectable by defining the surface of the folded end-product.

Typically, an apparatus 10 of the present invention will be placed and operated in an industrial laundry that supplies a flow of laundry items 5 as referred to, from a washer/drier to the apparatus 10, and the apparatus 10 may conveniently, as shown in FIG. 2, be formed as a single unit with a machine frame F carrying also dedicated equipment 500 configured to separate incoming laundry items 5 from one another, i.e. to individualise laundry items 5 of an incoming flow or of a batch of more or less intertwined laundry items 5 lying on a conveyor surface 510. Examples of such an individualising equipment are disclosed in FIG. 1 of WO19137585 and in DK 2022 00437.

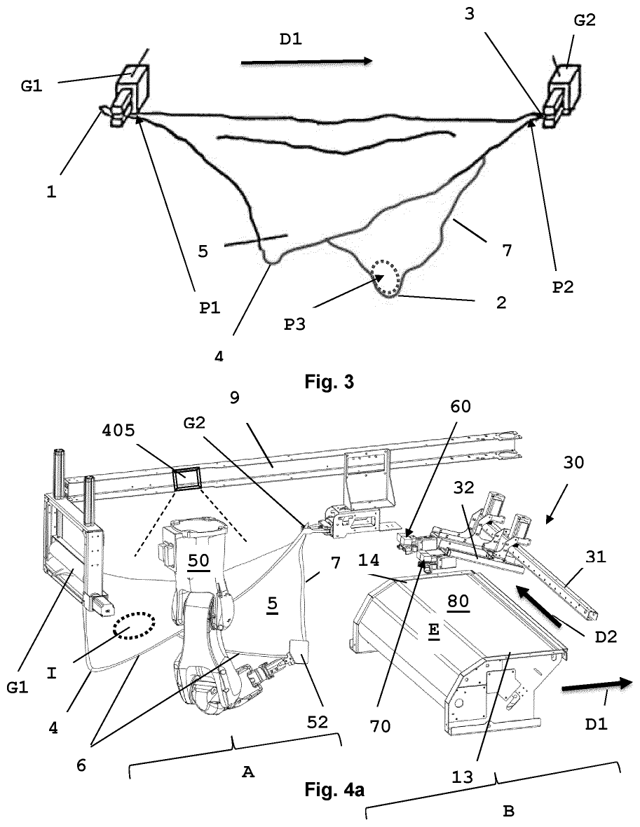

As shown in FIG. 2, the apparatus 10 includes a first section A with components configured for presenting each individual laundry item 5, that is received from the aforementioned dedicated individualising equipment 500, in a regular manner shown schematically in FIG. 3, to a transfer mechanism 50, exemplified in the following by a robot, which transfer mechanism has a movable clamp 52.

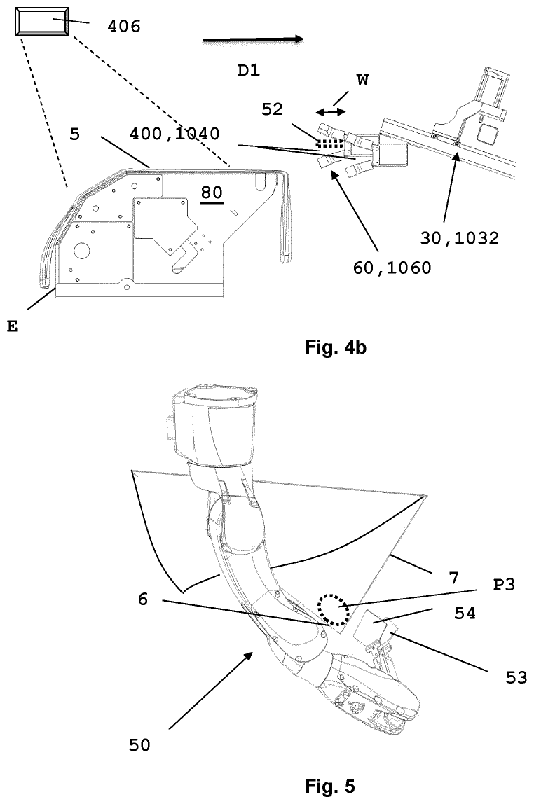

The movable clamp 52, shown in FIG. 4a as being mounted to the end of a robotic manipulator arm, receives, holds on to, and transfers the individual laundry items 5 to a second, downstream section B of the apparatus 10, in accordance with a digitally stored pre-determined processing schedule. For this, the clamp 52 is preferably arranged to be moveable around in a 3-dimensional space.

The second section B has various orienting components to be described below, which orienting components are configured for receiving and capturing a laundry item 5 released by the clamp 52, for spreading out the captured laundry item 5, and for then orienting the laundry item 5 where necessary, i.e. for correcting the orientation of the laundry items 5 where necessary.

Within the second section B is preferably also a laundry item receiving surface 80 on which the laundry items 5 are partially supported while being oriented and from which the oriented laundry items 5 are advanced by a downstream discharge conveyor 11 to a laundry folding machine (not shown). As a result of the orienting each laundry item 5 may have one pair of opposite sides 6, 7 aligned with the direction along which the laundry item 5 is advanced by the discharge conveyor 11. The receiving surface 80 may in one embodiment be defined by a moving conveyor belt, or the receiving surface 80 may be a stationary, smooth surface.

The apparatus 10 also includes various sensors and/or cameras and a controller, configured i.a. to register, identify and classify each item 5 and to then instruct, or organize, processing of the items 5 one after another by the transfer mechanism 50, in accordance with the aforementioned pre-determined schedule. The controller is schematically shown and referenced by numeral 12 in FIG. 2; a remotely controlled, wireless operation is also foreseen.

In the following, reference will be made to a first machine direction D1 of the apparatus 10, and to a second, normally horizontal machine direction D2 of the apparatus 10, which second machine direction D2 extends perpendicularly or near-perpendicularly to the first machine direction D1. The downstream discharge conveyor 11 may be arranged to advance laundry items 5 in a direction or plane coincident with the first machine direction D1, and the first machine direction D1 may be coincident with a machine direction of a downstream laundry folding machine.

Referring now to FIG. 3, two gripper components G1, G2 within the first section A of the apparatus 10 carry out a first process involving the manipulation of each laundry item 5 by a diagonal stretching where two diagonally opposite corners 1, 3 are pulled away from each other. For this, a first laundry item portion P1 near, and optionally including the first corner 1 of each laundry item 5 leaving the individualising equipment 500, is captured and held by a first gripper G1, and a second laundry item portion P2 near, and optionally including the diagonally opposite second corner 3 of the laundry item 5 is then captured by a second gripper G2. Locating and capturing such opposite portions P1, P2 of a laundry item 5 using a first gripper G1, that may be defined by a pair of opposed rollers (as shown in FIG. 4a), and a second gripper G2 is a process well-known in the art. An example of an apparatus suitable for this procedure is disclosed in U.S. Pat. No. 6,584,711.

FIG. 3 shows the aforementioned second gripper G2, which may be arranged to be movable in the first machine direction D1, having captured the second laundry item portion P2 and having then carried out the aforementioned pulling apart of the first and second geometric corners 1, 3 from each other by moving along primary beam 9 (see FIG. 4a) away from the first gripper G1 while the first laundry item portion P1 remains held by the first gripper G1. As shown, this process generally results in the two remaining diagonally opposite geometric corners 2, 4 hanging suspended in the aforementioned more or less regular manner, with one of the two corners, referred to in the following as the third corner 2 of the laundry item 5, hanging closer to the second gripper G2 than the diagonally opposite fourth corner 4 of the laundry item 5.

One or more detectors, such as camera 405, are arranged and configured to register the position of the third corner 2, to which corner 2 the clamp 52 is then to be moved, and also to allow for the generation by the controller 12 of information representing the particular laundry item 5, such as based on the distance between the first and second corners 1, 3. This information may alternatively be generated based on data obtained upstream of the illustrated process stage, and may reflect size and nature/type/colour of the laundry item 5 by comparing data registered by the camera with information contained in a data library. This procedure generates the pre-determined processing schedule digitally stored in the controller 12 and to be applied with regard to each respective laundry item 5.

Detectors, such as the camera 405, may also be arranged to register any presence on one surface of the laundry item 5 of indicia I, or a laundry item 5 identifier, and the controller 12 may, in accordance with the digitally stored predetermined schedule, instruct the robot 50 to then manipulate the laundry item 5 in such a way that this particular surface will be deposited on the discharge conveyor 11 facing upwards, or downwards, depending on the folding by the laundry folding machine, such that for the folded end-product the indicia I is readily visible or inspectable by that surface facing outwards.

FIG. 4a shows the first section A of the apparatus 10, with the third corner 2 being presented to the robot 50. FIG. 4b on the other hand shows a laundry item 5 having been oriented and deposited lying flat on the receiving surface 80, ready to be caught and advanced by a discharge conveyor 11 (not shown).

Shown in FIG. 4a is also the clamp 52, configured to catch, by a controlled movement of the transfer mechanism 50, a hanging third portion P3 of the laundry item 5, shown here as near and optionally including the third geometric corner 2. FIG. 4a shows the third portion P3 having been received by the clamp 52.

Also shown in FIG. 4a are two clamping devices 60, 70 that define in part the aforementioned orienting components of the second section B of the apparatus 10, and to which the laundry item 5 is delivered in a next step.

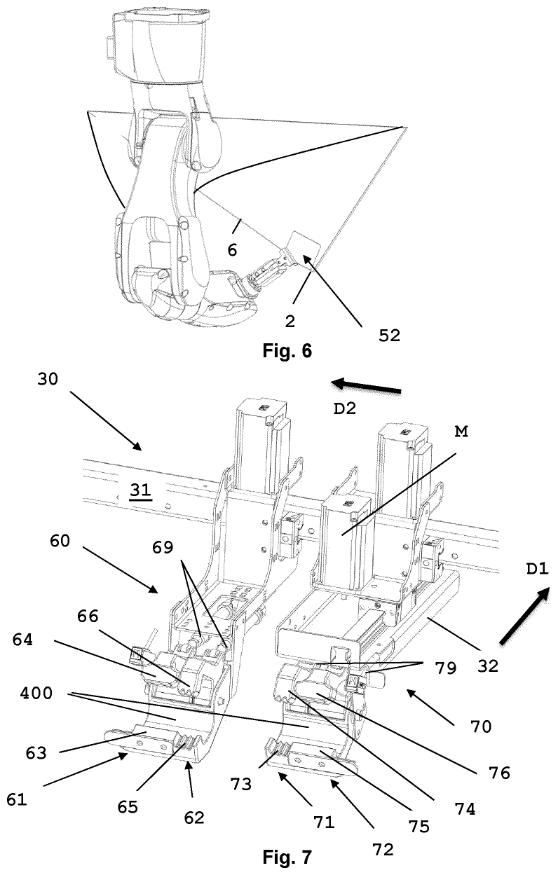

As shown in FIGS. 4a, 5 and 6 the clamp 52 is configured to be movable into a position adjacent a selected side 6, 7 of the laundry item 5 at the third corner 2, such that the clamp 52 may attack the laundry item 5 from either a short side 7 (see FIG. 5) or a longer side 6 (see FIGS. 4a and 6) thereof. Selection depends on the laundry item 5 being processed, in particular on the dimension thereof, or on the nature or type thereof, such as whether it is a bath mat or a small or a large towel, as per the generated information. The selection is carried out according to the aforementioned processing schedule stored in the controller 12. Through this selection either a short side 7 or a long side 6 may be presented to the two clamping devices 60, 70, and the presented side then becomes what may be referred to as a leading side of the laundry item 5 at the time it reaches the folding machine. The selected side will in the following also be referred to as a first side of the laundry item 5 while two other opposite sides will be referred to as second and third sides of the laundry item 5.

By way of example, when the laundry item 5 is a bath mat it may be required that the shorter sides 7 be aligned with the first machine direction D1, and for that case a longer side 6 is attacked, as shown in FIG. 6.

When for a given laundry item 5 the clamp 52 has reached the selected and pre-determined position, two opposite jaws 53, 54 (see FIG. 5) of the clamp 52 move to a closed position pressing against a respective surface of the laundry item 5, and the laundry item 5 is then released from the first and second grippers G1, G2, upon the controller 12 having received sensors signals confirming that the third portion P3 has been caught between the opposite jaws 53, 54. The laundry item 5 then hangs suspended from the clamp 52 within the first section A.

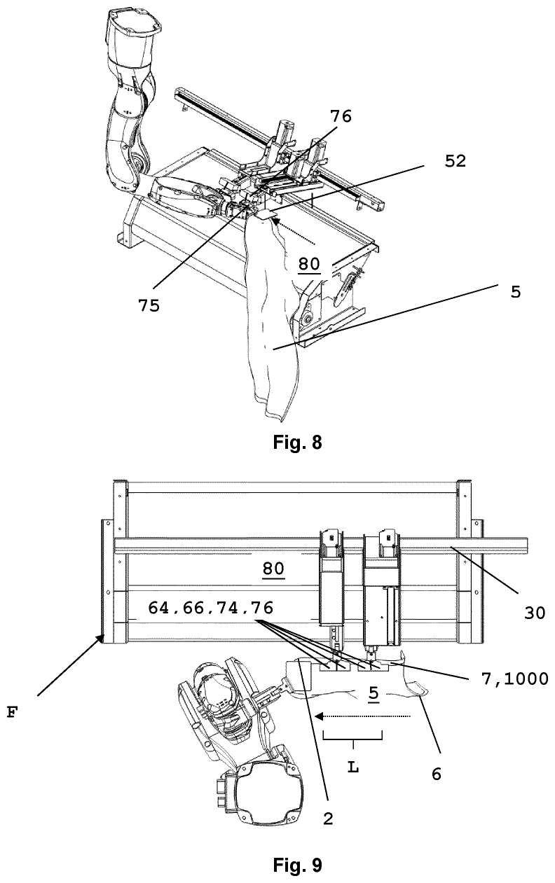

At this time the controller 12 directs the transfer mechanism 50 to move the clamp 52 holding the third portion P3 of the laundry item 5 into a predetermined position above a front end E of the receiving surface 80, having also instructed the two clamping devices 60, 70 that define in part the orienting device, to move into a corresponding receiving and capturing position next to each other, and to assume a capturing configuration. In the capturing position, the clamping devices 60, 70 are typically positioned closer to one side 14 of the receiving surface 80 than to the opposite side 13 of the receiving surface 80 (see FIG. 4a) or vice versa as shown in FIG. 8.

The two clamping devices 60, 70 are displaceably mounted to a sub-frame 30 supported by the frame F and extending across and above the receiving surface 80, as seen best in FIG. 9, such that the two clamping devices 60, 70 may be moved independently relative to one another parallel with the shown second machine direction D2, which is perpendicular to the first machine direction D1, away from and into the aforementioned receiving and capturing position, controlled by the controller 12 of the apparatus 10 and under the action of a respective drive (not shown).

The sub-frame 30 carries a supporting bar 32, and one clamping device, referred to in the following as the second clamping device 70, of the two clamping devices 60, 70 is mounted so as to be also movable back and forth parallel with the first machine direction D1, along the supporting bar 32 by activation of a drive M, compare FIGS. 9 and 15.

The sub-frame 30 itself is arranged to be movable relative to the frame F in the first direction D1, from a first position next to the front end E of the receiving surface 80, as shown in FIG. 4a, to a second position above a rear end of the receiving surface 80, as shown in FIG. 4b, and back again when not carrying any laundry item 5.

As will be understood from the following, the overall purpose of the shown orienting components 30, 60, 70 is:
a) to receive and to fully spread out the laundry item 5 while hanging suspended from the two clamping devices 60, 70, by moving—in a laundry item receiving and spreading out procedure—the two clamping devices 60, 70 apart in a direction parallel with the second machine direction D2,
b) to orient the laundry item 5 where necessary through an alignment procedure, by moving the second clamping device 70 along the supporting bar 32, such that a selected pair of opposite sides 6, 7 of the laundry item 5 become aligned with the machine direction D1, and
c) to allow the aligned laundry item 5 to be advanced by the discharge conveyor 11 by movement of the sub-frame 30 to its second position shown in FIG. 4b.

Each clamping device 60, 70 has a first pair 62, 71 and a second pair 61, 72 of opposite jaws, as seen best in FIG. 7, with each of the pairs having a first jaw 63, 65, 73, 75 and an opposite second jaw 64, 66, 74, 76. The opposite jaws 65, 66; 73, 74 of the first pairs 62, 71 have serrated or profiled engagement faces while at least some of the opposite jaws 63, 64, 75, 76 of the second pairs 61, 72 may have smooth or planar faces. A respective drive 69, 79 operate each pair 61, 62, 71, 72 for opening the jaws, i.e. spreading the opposite jaws apart, and for closing the jaws.

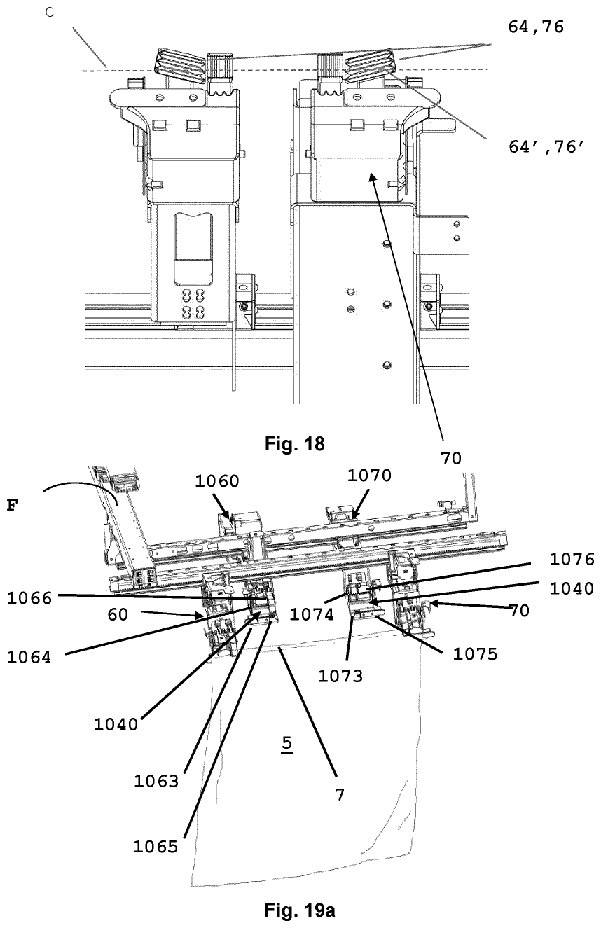

The serrations of some of the jaws 65, 66, 73, 74 provide a toothed surface to bite into the laundry item 5, which bite is preferred to fix the laundry item 5 against movement relative to those jaws 65, 66, 73, 74; alternatively, some of the jaws may be formed as pins with a small contact surface to provide for such a bite. FIG. 18 shows profiling 64′, 76′ of the engagement face of some of the jaws 64, 76; this profiling in the form of serrations is formed by teeth extending at an angle to the shown line C, which is parallel with the second machine direction D2, may in certain embodiments be applied to where necessary assist in drawing the first side of the laundry item 5 further into the gap 400 as the two clamping devices 60, 70 are moved apart, thereby further ensuring, in the case of very heavy laundry items 5, that the laundry item 5 does not fall from the clamping devices 60, 70.

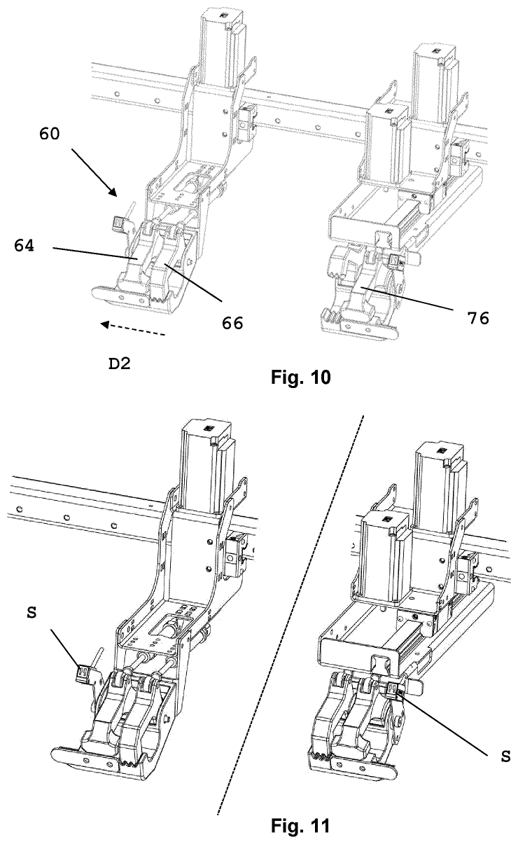

At least one of the jaws of each pair 61, 62, 71, 72 is movable to and from the corresponding opposite jaw, by the action of the respective actuator 69, 79 controlled by the controller 12. In this way each pair 61, 62, 71, 72 of opposite jaws may, independently of each other, assume an open, capturing configuration shown in FIG. 7 where both clamping devices 60, 70 are ready to receive a laundry item 5 from the clamp 52, and a closed, holding configuration wherein the laundry item 5 is held in between pairs of opposite jaws, compare FIGS. 10 and 11.

FIG. 7 shows the two clamping devices 60, 70 in the open, capturing configuration, being positioned next to each other and ready for receiving a length L (see FIG. 9) of a first side 6, 7 of a laundry item 5 within aligned gaps 400 between the opposite jaws of all four pairs 61, 62, 71, 72 of jaws. The individual gaps 400 preferably have each a depth W, as seen in FIG. 4b, suitable for receiving the length L of the first side 6, 7 presented by the clamp 52, i.e. a portion of the narrow hem Hand woven part of the laundry item 5.

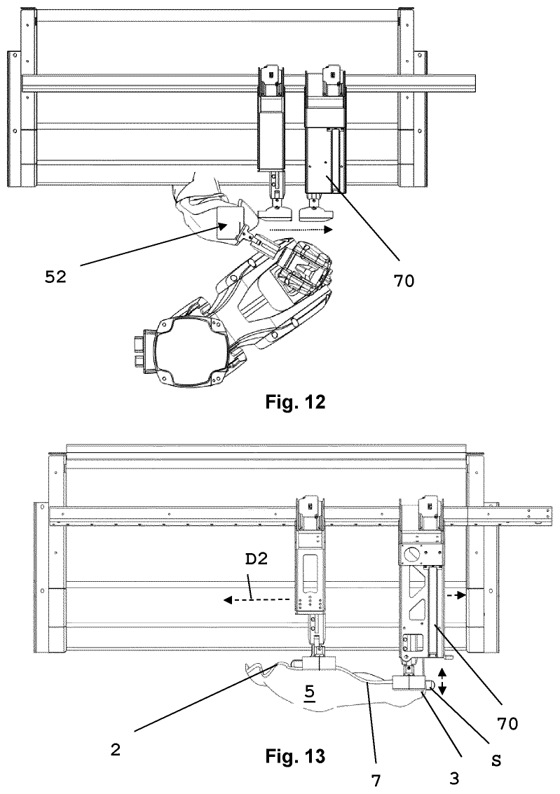

With the two clamping devices 60, 70 in the shown position and configuration, the clamp 52, positioned first as shown in FIG. 8, is moved right-to-left to drape the aforementioned length L of the laundry item 5 over the four adjacent lower jaws 63, 65, 73, 75, by the clamp 52 moving inside and along the aforementioned gap 400 from right to left, drawing thereby the length L of the first side 6, 7 into the gaps 400, as shown in FIG. 9. This draping procedure leads to the length L of the first side 6, 7 being received between the opposite jaws in the manner shown in FIG. 17, sometimes-in imperfect situations-with a small back folded portion between the opposite jaws. Such imperfect situations require a subsequent orienting/aligning of the laundry item 5.

Where the laundry item 5 carries an indicia I the clamp 52 may be controlled to insert the laundry item into the aligned gaps 400 left-to-right, seen in the machine direction D1, to ensure that the surface carrying the indicia I is deposited facing upwards on the receiving surface 80, compare FIGS. 8 and 12 where this opposite movement of the clamp 52 is illustrated by arrows.

The clamping devices 60, 70 are then put in a closed configuration shown in FIG. 9, to hold on to the laundry item 5, which is then released from the clamp 52.

FIG. 9 shows the two clamping devices 60, 70 from above, in the configuration shown in FIG. 10 wherein a part of the length L is firmly sandwiched between the serrated opposite jaws 65, 66 of the first clamping device 60, by those jaws 65, 66 biting into the laundry item 5. Additionally, or alternatively where there is no serration, a relatively high clamping force may be established onto the laundry item 5 by the first clamping device 60 via the corresponding actuator 69.

As also shown in FIG. 10, one of the pairs of jaws 75, 76 of the second clamping device 70 is also put in a closed configuration, albeit with a lower clamping force applied against the laundry item 5.

Hence, in the aforementioned closed configuration the laundry item 5 is prevented from falling off the clamping devices 60, 70 occasioned by its weight.

The clamp 52 is then moved away, back to the first section A of the apparatus 1.

To carry out a subsequent laundry item spreading out operation the first clamping device 60 is then moved in the second machine direction D2, as shown in FIG. 10, drawing with it the length of the laundry item 5 held between its opposite jaws 64, 64, 65, 66. By the second clamping device 70 standing still, and by applying a lower clamping force against the laundry item 5 or by the faces of the opposed jaws 75, 76 being profiled to provide a reduced resistance against relative movement of the laundry item 5 along the second machine direction D2 compared to the first direction D1, a length of the laundry item 5 along the first side slides thereby between the opposite jaws 75, 76 of the second clamping device 70.

Some of the jaws may have rollers providing a clamping force against the laundry item 5 while at the same time allowing for a reduced-friction movement along the first side of the clamping devices relative to the laundry item, less akin to a sliding movement.

This movement of the first clamping device 60 continues until a sensor S associated with the second clamping device 70, which sensor S may eg. be of the light beam type, registers that the laundry item 5 has been drawn so far relative to the second clamping device 70 that a second side and/or a corner 2 of the laundry item 5 has reached the second clamping device 70, cf. FIG. 13.

The configuration of the clamping devices 60, 70 is then changed such that the second clamping device 70 now is brought to firmly hold onto the laundry item 5, and such that the laundry item 5 may now slide relative to the first clamping device 60, by either a continued movement of the first clamping device 60 in direction D2 with the second clamping device 70 held stationary, or by the second clamping device 70 now being moved against the machine direction D2 with the first clamping device 60 held stationary. In other words: the two clamping devices 60, 70 are again moved away from each other such that the second clamping device 70 approaches the third side 6 of the laundry item 5, which third side is opposite the aforementioned second side 6.

This further movement continues until a sensor S associated with the first clamping device 60 registers that the laundry item 5 has been drawn so far relative to the first clamping device 60 that the aforementioned third portion P3 previously held by the clamp 52 has reached the first clamping device 60, indicating that the laundry item 5 has now been fully spread out.

By the sub-frame 30 being in its first position, with the clamping devices 60, 70 also located in front of the front end E of the receiving surface 80, the laundry item 5 at this time briefly hangs fully suspended from the clamping devices 60, 70, held only at its upper corners 2, 3.

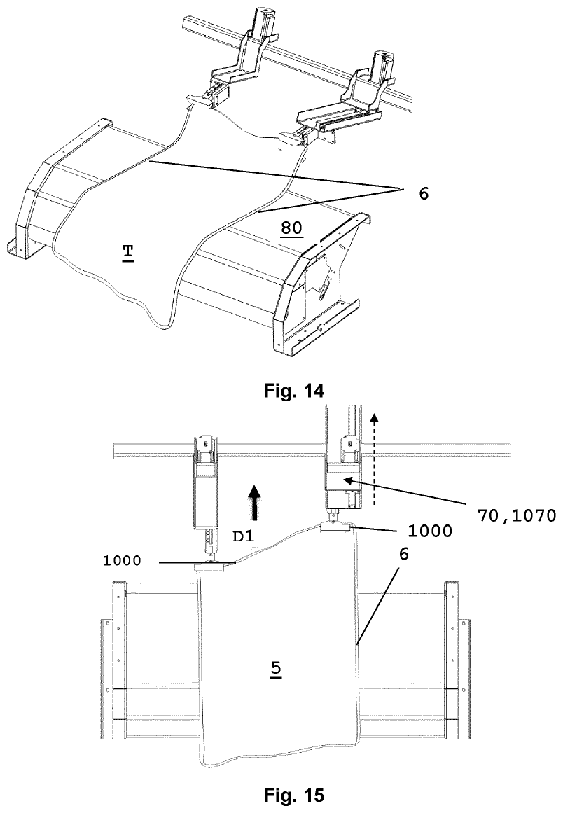

The sub-frame 30 with the two clamping devices 60, 70 is now moved in the first machine direction D1, cf. FIG. 14.

It is noted that the receiving surface 80 may have a moving upper surface defined by eg. a conveyor belt, configured to move against the machine direction D1, whereby a trailing portion T of the hanging laundry item 5 may now be caught by this conveyor belt, leading to some further stretching out of the hanging laundry item 5.

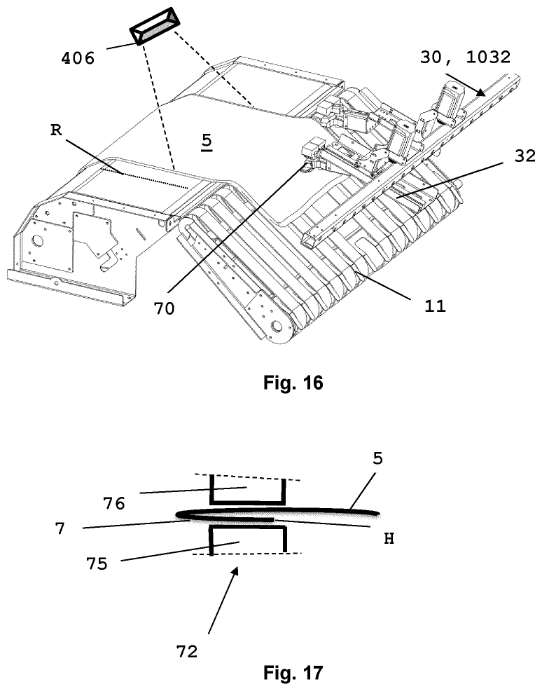

As the laundry item 5 is drawn forward in the first machine direction D1 by the moving sub-frame 30 a further sensor, such as overhead camera 406 shown in FIG. 16, registers any angular misalignment of the opposite sides 6 of the laundry item 5 relative to a reference line R representing the first machine direction D1. Such a misalignment may arise in the aforementioned imperfect situations where differently sized portions of the laundry item 5 are received by the two clamping devices 60, 70 along the length of the aligned gaps 400. Hence, carrying out an alignment procedure may be warranted.

To correct for any misalignment the second clamping device 70 may in a first embodiment now be moved in the machine direction D1 relative to the first clamping device 60, as shown schematically in FIG. 15 illustrating a situation where a portion 1000 of the laundry item 5 held between the jaws 73, 74, 75, 76 of the second clamping device 70 is smaller than the corresponding portion held by the jaws 63, 64, 65, 66 of the first clamping device 60, compare FIGS. 9 and 15. This movement may be by moving the second clamping device 70 along the supporting bar 32 discussed above and shown schematically in FIG. 4a. The second clamping device 70 may alternatively or additionally be configured to carry out this relative movement already during the spreading out step, as shown by the double arrow in FIG. 13.

A second and a third further embodiment of the present invention will now be discussed.

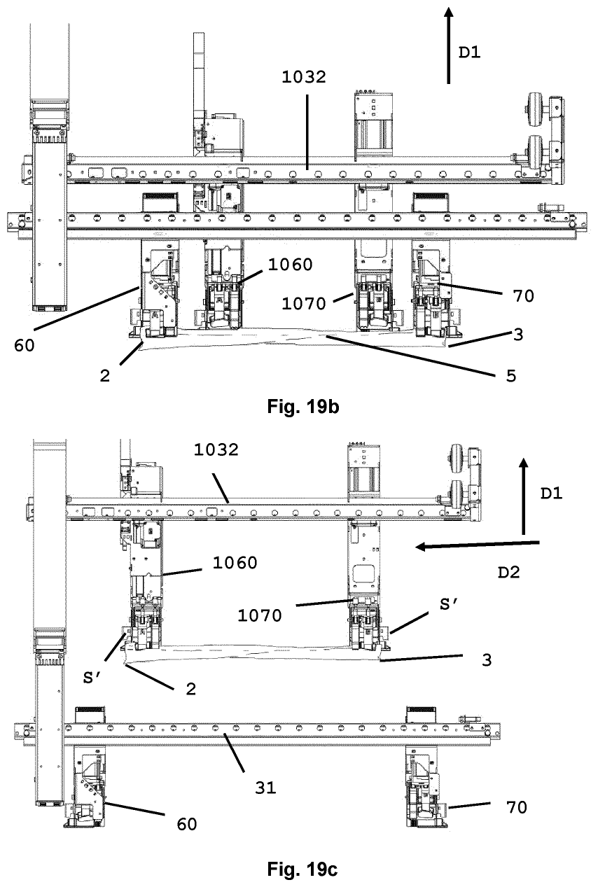

According to a second, further embodiment of the present invention the aforementioned aligning procedure involves the use of two dedicated laundry item 5 aligning clamps 1060, 1070 shown in FIGS. 19a, 19b and 19c and configured to move parallel with the first machine direction D1 into positions downstream of the two clamping devices 60, 70.

More specifically, FIG. 19a shows the two aligning clamps 1060, 1070 as including respective upper and lower clamping jaws 1063, 1064, 1065, 1066, 1073, 1074, 1075, 1076 that define between them, when the aligning clamps 1060, 1070 are open with the jaws spread apart, aligned further gaps 1040, further to the gaps 400 of the first and second clamping devices 60, 70. The clamping jaws 1063, 1064, 1065, 1066, 1073, 1074, 1075, 1076 are preferably configured in the same manner as the jaws of the two clamping devices 60, 70, as discussed above.

The two aligning clamps 1060, 1070 may be moved together parallel with the first machine direction D1 into a first position with the further gaps 1040 being aligned with the first side 6, 7 of the laundry item 5 being held by the two clamping devices 60, 70, in which first position the clamping jaws 1063, 1064, 1065, 1066, 1073, 1074, 1075, 1076 are then closed to hold on to the first side 6, 7 of the laundry item 5 by engaging opposite surfaces of the laundry item 5 between the narrower gaps 1040, as shown in FIG. 19b. The laundry item 5 is then released from the two first and second clamping devices 60, 70 and is then effectively taken over by the aligning clamps 1060, 1070.

As shown in FIG. 19b, in the first position the two aligning clamps 1060, 1070 are positioned between the clamping devices 60, 70 which have previously moved away from each other to a respective corner 2, 3 of the laundry item 5, as described with reference to FIG. 13. For the aligning clamps 1060, 1070 to then hold on to the same corners 2, 3, the two aligning clamps 1060, 1070 are displaceably mounted to be movable independently of one another parallel with the second machine direction D2, along a supporting bar 1032, in the same manner as described with respect to the two clamping devices 60, 70. The aligning clamps 1060, 1070 hence may be moved to a respective one of the corners 2, 3, see FIG. 19c, using sensors S′ mounted to each aligning clamp 1060, 1070, similar to the sensors S of the first and second clamping devices 60, 70.

The aligning clamps 1060, 1070 holding on to the laundry item 5 are then controlled to move together along the machine direction D1, to eventually deposit the laundry item 5 on the discharge conveyor 11 (see FIG. 16), and also to move independently of one another parallel with the first machine direction D1, to thereby carry out the alignment procedure as shown in FIG. 15, when any misalignment is detected. Hence, the aligning clamps 1060, 1070 of the second embodiment are included to perform the aligning procedure carried out by the clamping devices 60, 70 of the first embodiment, cf. FIG. 15, whereby an increased capacity of the apparatus 10 is achieved in that the clamping devices 60, 70 are freed to carry out only the initial laundry item 5 receiving and spreading out procedure.

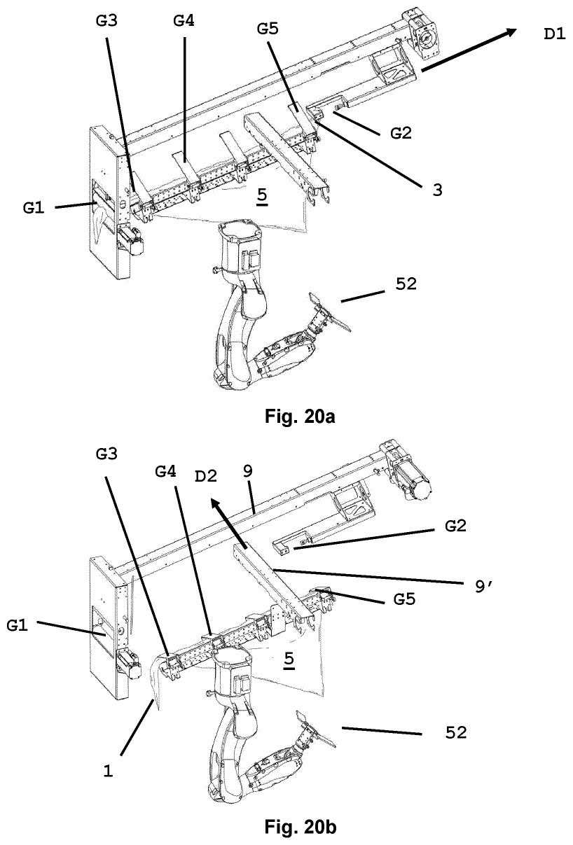

According to a third, further embodiment the aforementioned first process shown in FIG. 3, wherein a first and second gripper G1, G2 pull two diagonally opposite corners 1, 3 away from each other, comprises a supplementary step, outlined in FIGS. 20a and 20b.

In this supplementary step at least two presenting grippers G3, G4 and G5 are arranged and configured to take over the laundry item 5 from the first and second grippers G1, G2 and to then present the laundry item 5, with the diagonally opposite corners 2, 4 also hanging suspended, essentially as shown in FIGS. 3, 4a, 5, 6 and 20b, to the robot 50, for the movable clamp 52 thereof to catch the hanging third portion P3 at the corner 2 in the manner shown in FIGS. 4a, 5 and 6. The presenting grippers G3, G4 and G5 effectively serve a buffer function freeing up the capacity of the first and second grippers G1, G2 while the downstream processes are carried out.

More specifically, FIG. 20a shows the first and second grippers G1, G2, of which the second gripper G2 is movable along the primary beam 9 in the first machine direction D1 for the stretching out of the laundry item 5, being supplemented by the presenting grippers G3, G4, G5 that are arranged and configured to i) be moved towards the first and second grippers G1, G2, supported by a secondary beam 9′ supported by the machine frame F, parallel with the second machine direction D2, ii) take over the laundry item 5 from the first and second grippers G1, G2 by gripping and holding the laundry item 5 at or near the two diagonally opposite corners 1, 3 held by the first and second grippers G1, G2 and iii) then move away from the first and second grippers G1, G2 towards the robot 50 supported by the machine frame F, to present the laundry item 5 with the laundry portion P3 still hanging down to the movable clamp 52, for iv) the clamp 52 to catch the hanging laundry portion P3. In this manner an increased capacity of the apparatus 10 is achieved in that the first and second grippers G1, G2 are freed to carry out a next pulling apart of corners of a (subsequent) laundry item.

As may be understood from the foregoing, in particular by inspection of the appended drawings, selecting a correct direction from which the corner 2 to be clamped is attacked by the clamp 52 may significantly, depending on the design of the robot 50, ease insertion of the clamp 52 into the gaps 400 of the two clamping devices 60, 70, as well as the subsequent draping of the length L of the first side of the laundry item 5 across the lower jaws 63, 65, 73, 75.

Actions that may be performed with the method and apparatus of the invention may be summarised as follows:

TABLE 1

| infor- | | | | |
|---|---|---|---|---|
| mation | Action1 | Action 2 | Action 3 | Action 4 |
| Laundry | Insert laundry item 5 from | | | |
| item 5 has | left to right, or from right | | | |
| indicia I | to left, for indicia I to face | | | |
| | upwards | | | |
| Laundry | | Attack laundry item 5 | Move clamping de- | Move sub frame 30 |
| item 5 is | | from short side 7 and | vices 60, 70 apart until | along direction D1 |
| bath mat | | drape a length L of | corners 2, 3 at short | and where necessary |
| | | long side 6 over lower | side 7/opposite short | adjust position |
| | | jaws 63, 65, 73, 75 | sides 7 reached | of second clamping |
| | | | | device 70 relative |
| | | | | to first clamping |
| | | | | device 60 in direction |
| | | | | D1 to align item 5 |
| Laundry | | Attack laundry item 5 | Move clamping de- | Move sub frame 30 |
| item 5 is | | from long side 6 and | vices 60, 70 apart until | along direction D1 |
| towel | | drape a length L of | corners 1, 2 at long | and where necessary |
| | | short side 7 over lower | side 6/opposite long | adjust position |
| | | jaws63, 65, 73, 75 | sides 6 reached | of second clamping |
| | | | | device 70 relative |
| | | | | to first clamping |
| | | | | device 60 in direction |
| | | | | D1 to align item 5 |

1. An apparatus for the processing of a clean/washed generally rectangular laundry item, said apparatus defining a first machine direction and comprising:
a laundry item transfer mechanism comprising a movable clamp;
grippers configured for holding a generally rectangular laundry item at or near two diagonally opposite corners of said generally rectangular laundry item, in a stretched out configuration and for presenting a hanging laundry item portion of said generally rectangular laundry item near or at one other corner of said generally rectangular laundry item to said movable clamp;
two clamping devices for clamping engagement with said generally rectangular laundry item, said two clamping devices being displaceably mounted to be movable independently of each other parallel with a second machine direction;
said movable clamp being movable from left to right or from right to left, seen in said first machine direction into and along a gap between opposite jaws of said two clamping devices.

2. The apparatus according to claim 1, wherein one of said two clamping devices also being movable back and forth parallel with said first machine direction relative to another of said two clamping devices.

3. The apparatus according to claim 1, comprising sub-frame carrying said two clamping devices, said sub-frame being movable in said first machine direction from a first position above and in front of a front end of a laundry item receiving surface to a second position above a rear end of said laundry item receiving surface.

4. The apparatus according to claim 3, wherein said laundry item receiving surface is defined by a conveyor belt.

5. The apparatus according to claim 1, wherein said second machine direction is perpendicular to said first machine direction;
wherein said apparatus further comprising two aligning clamps for clamping engagement with said generally rectangular laundry item, wherein:
said two aligning clamps comprising respective clamping jaws and each defining a further gap when said two aligning clamps are open;
said two aligning clamps being mounted to be movable independently of one another parallel with said second machine direction;
said two aligning clamps also being movable back and forth parallel with said first machine direction, between a position downstream of said two clamping devices and a first position with each further gap being substantially or fully aligned with said opposite jaws of said two clamping devices; and,
at least one of said two aligning clamps further being displaceably mounted to be movable relative to another one of said two aligning clamps parallel with said first machine direction.

6. The apparatus according to claim 1, said grippers configured for pulling apart two diagonally opposite corners of said generally rectangular laundry item, and said apparatus further comprising second grippers arranged and configured to take over said generally rectangular laundry item from said grippers by holding said generally rectangular laundry item at or near said two diagonally opposite corners and to then present said generally rectangular laundry item with said laundry item portion still hanging, to said movable clamp, for said movable clamp to catch said laundry item portion that is hanging.

7. A method for processing a clean/washed generally rectangular laundry item, the method comprising:
receiving and holding on to a laundry item portion near or at one corner of a generally rectangular laundry item by a movable clamp of a laundry item transfer mechanism;
then draping, by said movable clamp, a length of a first side of said generally rectangular laundry item adjacent to said one corner over clamping jaws of two clamping devices, by inserting said movable clamp into gaps between opposite jaws of said two clamping devices followed by a relative movement between said movable clamp and said two clamping devices;
holding on to said length of said first side of said generally rectangular laundry item by said two clamping devices, and then releasing said laundry item portion from said movable clamp;
then moving said two clamping devices away from each other along said first side, with said generally rectangular laundry item hanging from said two clamping devices, towards two respective opposite second side and third side of said generally rectangular laundry item;
then transferring said generally rectangular laundry item directly from said two clamping devices to two aligning clamps;
then moving said two aligning clamps away from each other along said first side, with said generally rectangular laundry item hanging from said two aligning clamps, to said two respective opposite second side and said third side of said generally rectangular laundry item; and
advancing said generally rectangular laundry item hanging from said two aligning clamps in a machine direction.

8. The method according to claim 7, comprising carrying out an alignment of said generally rectangular laundry item hanging from said two aligning clamps by a movement of said two aligning clamps relative to one another along said machine direction.

9. The method according to claim 7, wherein said moving of said two clamping devices is carried out while said generally rectangular laundry item hangs freely from said two clamping devices.

10. The method according to claim 7, wherein said generally rectangular laundry item is presented to said movable clamp hanging from grippers in a diagonally stretched configuration, wherein said laundry item portion near or at said one corner being a hanging portion of said generally rectangular laundry item.

11. The method according to claim 7, wherein, to carry out said draping, said movable clamp is passed over respective lower jaws of said two clamping devices, within said gaps.

12. The method according to claim 7, wherein said moving of said two clamping devices is performed sequentially by first moving one of said two clamping devices along said first side towards one of said opposite second side and third side, and then moving another one of said two clamping device along said first side towards another of said opposite second side and third side.

13. The method according to claim 7, wherein said moving of said two aligning clamps is performed sequentially by first moving one of said two aligning clamps along said first side to one of said opposite second side and third side sides, and then moving another one of said two aligning clamps along said first side to another one of said opposite second side and third side.

14. A method for the processing of a clean/washed generally rectangular laundry item using an apparatus comprising:
a laundry item transfer mechanism comprising a movable clamp;
grippers configured for holding a generally rectangular laundry item at or near two diagonally opposite corners of said generally rectangular laundry item in a stretched out configuration and for presenting a hanging laundry item portion of said generally rectangular laundry item near or at one other corner of said generally rectangular laundry item to said movable clamp;
two clamping devices for clamping engagement with said generally rectangular laundry item, said two clamping devices being displaceably mounted to be movable independently of each other parallel with a second machine direction;
said movable clamp being movable from left to right or from right to left, seen in said first machine direction into and along a gap between opposite jaws of said two clamping devices; and
wherein the method comprises:
receiving and holding on to a laundry item portion near or at one corner of a generally rectangular laundry item by said movable clamp of a laundry item transfer mechanism;
draping, by said movable clamp, a length of a first side of said generally rectangular laundry item adjacent to said one corner over clamping jaws of said two clamping devices, by inserting said movable clamp into said gap between said opposite jaws of said two clamping devices followed by said relative movement from left to right or from right to left, seen in said first machine direction, between said movable clamp and said two clamping devices;
holding on to said length of said first side of said generally rectangular laundry item by said two clamping devices, and releasing said laundry item portion from said movable clamp;
moving said two clamping devices away from each other in said second machine direction along said first side, with said generally rectangular laundry item hanging from said two clamping devices, to locate two opposite second side and third side of said generally rectangular laundry item; and
advancing said generally rectangular laundry item hanging from said two clamping devices in said first machine direction.

15. The method according to claim 14, comprising carrying out an alignment of said generally rectangular laundry item relative to said first machine direction by a movement of said two clamping devices relative to one another along said first machine direction.

16. The method according to claim 14, wherein said moving of said two clamping devices is carried out while said generally rectangular laundry item hangs freely from said two clamping devices.

17. The method according to claim 14, wherein, prior to said draping by said movable clamp, said generally rectangular laundry is presented to said movable clamp hanging from grippers in a diagonally stretched configuration, said laundry item portion near or at said one corner being a hanging portion of said generally rectangular laundry item.

18. The method according to claim 14, wherein to carry out said draping by said movable clamp, said movable clamp is passed over respective lower jaws of said two clamping devices, within said gap.

19. The method according to claim 14, wherein said moving said two clamping devices is performed sequentially by first moving one of said two clamping devices along said first side until reaching one of said opposite second side and third side, and then moving another of said two clamping devices along said first side until reaching another one of said opposite second side and third side.

20. The method according to claim 7, wherein said advancing said generally rectangular laundry item hanging from said two aligning clamps in a machine direction is performed with a trailing portion of said generally rectangular laundry item lying against a receiving surface.

21. The method according to claim 12, wherein said moving said two clamping devices is performed with a sliding contact between the generally rectangular laundry item and the stationary one of said two clamping devices.

22. The method according to claim 13, wherein said moving said two aligning clamps is performed with a sliding contact between the generally rectangular laundry item and the stationary one of said two aligning clamps.

23. The method according to claim 14, wherein said advancing said generally rectangular laundry item hanging from said two clamping devices in said first machine direction is performed with a trailing portion of said generally rectangular laundry item lying against a receiving surface.

24. The method according to claim 19, wherein said moving said two clamping devices is performed with a sliding contact between the generally rectangular laundry item and the stationary one of said two clamping devices.
